(19) United States
(12) Patent Application Publication
(10) Pub. No.: US 2020/0161033 A1
(43) Pub. Date: May 21, 2020

(54) ANISOTROPIC MISCHMETAL- Fe-B PERMANENT MAGNET AND PROCESSING OF AN ANISOTROPIC MISCHMETAL-Fe-B PERMANENT MAGNET

(71) Applicant: FORD GLOBAL TECHNOLOGIES, LLC, Dearborn, MI (US)

(72) Inventors: Wanfeng LI, Novi, MI (US); Feng LIANG, Troy, MI (US); Michael W. DEGNER, Novi, MI (US); Chuanbing Rong, Canton, MI (US)

(21) Appl. No.: 16/196,836

(22) Filed: Nov. 20, 2018

(51) Int. Cl. H01F 1/057; C22C 38/00; B22F 3/16; B22F 3/24

(52) U.S. Cl. CPC H01F 1/0576; C22C 38/005; H01F 41/0273; B22F 3/24; B22F 3/16

(57) ABSTRACT

A method of forming a permanent magnet includes processing a mixture of mischmetal-Fe—B particles having an average MM₂Fe₁₄B grain size below 500 nm and low melting point (LMP) alloy particles into a compact defining grain boundaries between MM₂Fe₁₄B grains; hot-pressing the compact; and hot-deforming the compact to diffuse the LMP alloy particles into the grain boundaries, thickening the grain boundaries and modifying a surface region composition of the MM2Fe14B grains.

### TECHNICAL FIELD

The present disclosure relates to a rare earth permanent magnet, and a method of producing a rare earth permanent magnet.

### BACKGROUND

Rare earth permanent magnets (e.g., Nd—Fe—B magnets) have been essential for a wide range of applications including consumer electronics, home appliances, transportation, and medical facilities. In particular, the rapid development of green energy applications such as wind turbines, and electric vehicles have increased demand for permanent magnets containing expensive rare earth elements such as, for example dysprosium (Dy), terbium (Tb), neodymium (Nd), and praseodymium (Pr), among others. Rare earth (RE) elements are co-mined, and these four elements, Dy, Tb, Nd, and Pr, are only of a small fraction of the RE elements overall. Other RE elements, such as, but not limited to, cerium (Ce), and lanthanum (La), are much more abundant in nature.

At mines such as Mountain Pass mine in California, Ce concentration is about half of the rare earth mined overall. The concentration of Ce and La combined reaches about 82 wt. % of all the rare earth elements. Naturally, all the RE elements occur together in RE deposits, thus mining to extract one single RE element based on demand is not possible. Due to high abundance and low demand, Ce and La are significantly less costly than high demand elements such as Nd, Pr, and Dy. Conventionally, Ce and La need to be separated from the rare earth mixture because Ce and/or La-based magnets display inferior properties as compared to conventional Nd—Fe—B magnets. Specifically, conventional Ce and/or La containing sintered RE—Fe—B magnets have a lower coercivity than sintered Nd—Fe—B magnets.

### SUMMARY

According to one or more embodiments, a method of forming a permanent magnet includes processing a mixture of mischmetal(MM)-Fe—B particles having an average MM₂F₁₄B grain size below 500 nm and low melting point (LMP) alloy particles into a compact defining grain boundaries between MM₂Fe₁₄B grains; hot-pressing the compact; and hot-deforming the compact to diffuse the LMP alloy particles into the grain boundaries, thickening the grain boundaries and modifying a surface region composition of the MM₂Fe₁₄B grains.

According to at least one embodiment, hot-pressing may be conducted in a direction perpendicular to an alignment direction. In one or more embodiments, hot-pressing may be conducted at 600 to 950° C. In at least one embodiment, the method may further include forming the mischmetal-Fe—B particles by hydrogenation disproportionation desorption and recombination, wherein the mischmetal-Fe—B particles may be anisotropic. In some embodiments, processing may include aligning the mischmetal-Fe—B particles and pressing the mischmetal-Fe—B particles and LMP particles to form the compact. In certain embodiments, the mischmetal-Fe—B particles may include Tb, Dy, Nd, Pr, Ce, La, or mixtures thereof. In one or more embodiments, the mischmetal-Fe—B particles may include Co, Cu, Al, Ga, Zn, Si, Nb, Zr or mixtures thereof. According to at least one embodiment, the LMP alloy particles may include at least one rare earth element, and Cu, Al, Ga, Zn, Fe, Co, or mixtures thereof, and may have a melting point below 750° C. In certain embodiments, the mixture may include up to 30 wt. % of LMP alloy particles. In some embodiments, hot-deforming may include further aligning the mischmetal-Fe—B grains.

According to one or more embodiments, a method of forming a permanent magnet includes forming anisotropic mischmetal(MM)-Fe—B particles with an average MM₂Fe₁₄B grain size below 500 nm by hydrogenation disproportionation desorption and recombination; mixing the MM-Fe—B particles with low melting point (LMP) alloy particles to form a mixture; aligning and pressing the mixture into a compact defining grain boundaries between MM₂Fe₁₄B grains; and hot-pressing and hot-deforming the compact to diffuse the LMP alloy particles to thicken the grain boundaries.

According to at least one embodiment, hot-pressing may be conducted at 600 to 950° C. In one or more embodiments, the mischmetal-Fe—B particles may include Tb, Dy, Nd, Pr, Ce, La, or mixtures thereof and Co, Cu, Al, Ga, Zn, Si, Nb, Zr, or mixtures thereof. In certain embodiments, hot-pressing and hot-deforming the compact may modify a surface region composition of the MM₂Fe₁₄B grains. In some embodiments, the LMP alloy particles may include at least one rare earth element, and Cu, Al, Ga, Zn, Fe, Co, or mixtures thereof In at least one embodiment, the LMP alloy particles may have a melting point below 750° C.

According to at least one embodiment, a rare earth permanent magnet includes anisotropic mischmetal-Fe—B particles having an average MM₂Fe₁₄B grain size below 500 nm; and modified grain boundaries defined between MM₂Fe₁₄B grains. The modified grain boundaries including a low melting point (LMP) alloy, and a thickness of the modified grain boundaries is greater than a grain boundary thickness lacking the LMP alloy.

According to one or more embodiments, the mischmetal-Fe—B particles may include Dy, Tb, Nd, Pr, Ce, La, or mixtures thereof. In certain embodiments, the mischmetal-Fe—B particles may include Co, Cu, Al, Ga, Zn, Si, Nb, Zr, or mixtures thereof. In at least one embodiment, the LMP alloy may comprise at most 30 wt. % of the rare earth permanent magnet.

### BRIEF DESCRIPTION OF THE DRAWINGS

FIG. 1 shows a transmission electron microscope image of rare earth-Fe—B particles formed by hydrogenation disproportionation desorption and recombination (HDDR);

FIG. 2 shows an X-ray pole diagram of hard magnetic grain orientation distribution of rare earth-Fe—B particles formed by HDDR;

FIG. 3 is a scanning electron microscope image of rare earth-Fe—B powder formed by HDDR;

FIG. 4 is a schematic diagram of grain alignment (a) before and (b) after hot deformation, according to an embodiment;

FIG. 5 is a schematic diagram of grain boundaries (a) before and (b) after heat treatment, according to an embodiment; and

FIG. 6 is a graph showing demagnetization curves of bulk magnets.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

Rare earth (RE) elements have similar properties. Although the properties of RE elements may be similar, and for permanent magnet applications, all RE elements can form the RE₂Fe₁₄B phase, RE permanent magnets, hereinafter interchangeably referred to as RE-Fe—B magnets, based on less expensive RE elements tend to display inferior performance when compared with Nd—Fe—B magnets, or other RE permanent magnets including more expensive RE elements (such as, but not limited to Pr, Dy, and Tb). An anisotropy field is the theoretical value for measuring coercivity. The RE₂Fe₁₄B phase of most of the individual RE elements presents high magnetic anisotropic fields. For example, the major phase compound in an Nd—Fe—B magnet is Nd₂Fe₁₄B, which has a high anisotropy field of 73 kOe. Furthermore, CeCe₂Fe₁₄B has an anisotropy field of 26 kOe which is strong enough for high end applications such as traction motors and generators for electric vehicles if the anisotropy field can be fully converted into coercivity. Unfortunately, despite the similarity in properties between RE elements, RE permanent magnets including Ce and/or La display a significantly lower coercivity when compared to sintered Nd—Fe—B magnets. Typically, coercivity of Nd—Fe—B and other RE-Fe—B magnets can be improved by decreasing grain size. However, grain size refinement of sintered Nd—Fe—B magnets requires smaller particles. By decreasing particle size, it is more challenging to prepare the particles with desired size and homogeneity. Furthermore, smaller particle size in Nd—Fe—B magnets typically leads to a lower magnetic moment, which makes particle alignment in the magnetic field more difficult, thus reducing the remanence of the magnet.

According to embodiments, a RE permanent magnet and a processing technique to improve the coercivity and remanence of less expensive RE elements are disclosed. The less expensive RE element permanent magnet is hereinafter referred to as a mischmetal permanent magnet, or MM-Fe—B permanent magnet. Mischmetal refers to a mixed metal alloy of rare earth elements, such as light rare earth elements, including Ce and La. In certain instances, mischmetal may have the atomic ratio of the components in the naturally mined ores, including the Ce and La phases along with expensive rare earth phases such as Nd, Pr, Dy, and/or Tb. The atomic ratio varies from ore to ore depending on the particular ore mined, as such, the composition may have varying percentages of Ce and La. The processing method utilizes anisotropic mischmetal powders produced by hydrogenation disproportionation desorption and recombination (HDDR), which have finer grains than sintered magnets. The MM-Fe—B powders are mixed with low melting point alloy particles and consolidated into a green compact by hot-pressing. The subsequent hot-deformation of the green compact can improve the alignment and remanence of the permanent magnet. During both hot-pressing and hot-deformation, the low melting point alloy particles modify the microstructure of the permanent magnet by thickening grain boundaries, changing the composition of the grain boundaries, and/or modifying a surface region composition of the MM₂Fe₁₄B grains, and thus improve the coercivity of the magnet. As such, the demand for sparsely naturally-occurring RE elements can be decreased by using low-demand RE elements with improved resultant properties.

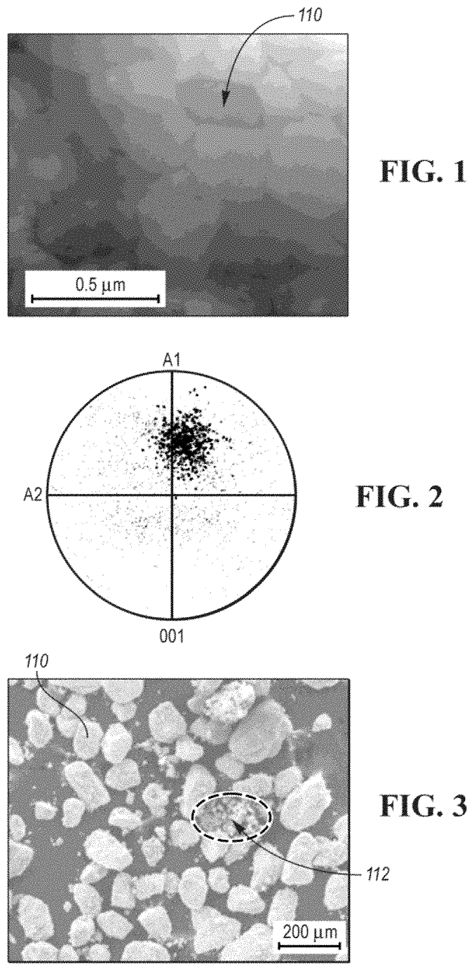

According to at least one embodiment, a method for forming an MM-Fe—B permanent magnet is disclosed. Anisotropic MM-Fe—B particle powders are prepared with MM₂Fe₁₄B average grain sizes below 500 nm. In certain embodiments, the MM-Fe—B particle powders may be processed by utilizing hydrogenation disproportionation desorption and recombination (HDDR) in order to produce anisotropic particles with grain sizes in some embodiments, from 100 to 500 nm, and in other embodiments 150 to 500 nm. As illustrated in FIG. 1, in certain embodiments, the average grain size of MM-Fe—B particles 110 formed by HDDR is much smaller than conventional sintered magnet grains, which are typically in the 3-10 μm range. In at least one embodiment, the MM of the MM-Fe—B powder includes at least one of Nd, Pr, Ce, and La. In some embodiments, the MM includes Ce and/or La. In at least one embodiment, the MM has the naturally occurring atomic ratio for rare earth elements, including the low anisotropy field Ce and/or La phases. In certain embodiments, Fe of the MM-Fe—B magnet further includes or is replaced by metallic elements such as, e.g., Co, Cu, Al, Ga, Si, Zn, Nb, Zr, or combinations thereof. The texture of the individual particles may vary, but the orientations of the grains have a substantially anisotropic distribution, as shown in FIG. 2.

In some embodiments where the MM-Fe—B particles are produced by HDDR, the particles themselves are anisotropic. The grain orientation of the MM-Fe—B particles produced by HDDR is not random, as shown by the pole distribution in FIG. 2. In some embodiments, anisotropic RE particles can be aligned by application of an external magnetic field. Further, the small grain size improves the coercivity of the resultant high abundance RE based permanent magnet when combined with delicate microstructure and controlled composition. Additionally, in one or more embodiments, the anisotropic fine-grained particles prepared by HDDR can be used to create a high-performance MM-Fe—B magnet, in which La and/or Ce can be included. Although Ce can be used as the only RE in the MM for the HDDR powder, mixtures of La and Ce may improve coercivity. For example, following heat treatment, La can diffuse into the grain boundaries, and improve the coercivity. The overall composition can be modulated according to demand for magnetic properties by adding mixture or individual RE elements and their alloys, e.g., adding more of the abundant La and/or Ce. In some embodiments, the MM-Fe—B powders are sieved to separate very small particles 112 from the MM-Fe—B particles 110, as illustrated in FIG. 3. The particles are sieved based on the particle size being too small to be aligned in a magnetic field. The ability to be aligned may depend on the field applied for alignment. In some embodiments, if a high pulse is applied, the smaller particles may not be excluded. In another embodiment, particles having an average size lower than 10 μm, may be sieved to maintain the remanence of the final magnet. In other embodiments, particles having an average MM₂Fe₁₄B grain size lower than 5 μm are sieved, and in yet another embodiment, particles having an average size lower than 4 μm are sieved. Alternatively, in certain embodiments, particles of larger than certain sizes can also be excluded by sieving or milling, such as jet milling or ball milling, as large particles may lower the anisotropy or may result in a lower density bulk magnet. For example, in certain embodiments larger than 500 μm can be excluded, in other embodiments, particles from 100 to 500 μm can be excluded, in some other embodiments, particles from 150 to 400 μm can be excluded, and in yet another embodiment, particles from 200 to 350 μm can be excluded.

In one or more embodiments, the method further includes mixing a low melting point (LMP) alloy with the MM-Fe—B powder. The LMP alloy may be an alloy between any of the RE elements, or combinations thereof, and other metallic elements, such as, but not limited to, Fe, Co, Cu, Al, Zn, Ga, or combinations thereof. In some embodiments, the LMP alloy includes at least 50 wt. % of the rare earth component. In other embodiments, the molar ratio between the rare earth component and the metallic elements is above 1. The LMP alloy may be prepared by arc-melting or any other suitable method. In certain embodiments, the composition of the alloy is selected such that the melting point of the alloy is below 750° C. As such, the composition should be around the eutectic point of the MM-LMP mixture. The LMP alloy is prepared into a powder for mixing with the MM-Fe—B powder. The LMP alloy powder may be prepared by any suitable method, including, but not limited to, milling into powder or melt-spinning the LMP alloy into ribbons for ball-milling into powder.

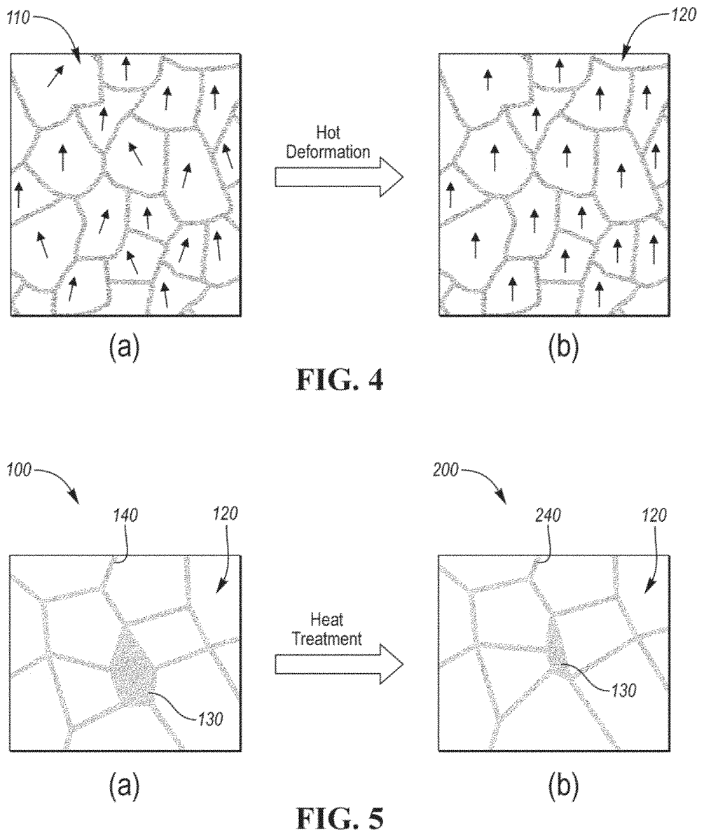

The MM-Fe—B powder and LMP alloy powders are then mixed to form a mixture. In certain embodiments, the percent of the LMP powder in the mixture at most 30% by weight, in other embodiments 5% to 30% by weight, and in yet another embodiment 10% to 25% by weight. Referring to FIG. 4, although the HDDR MM-Fe—B particles 110 themselves are anisotropic, the grains inside each particle are still misaligned, and their orientations form a distribution as shown for the grain alignment in FIG. 4(a). The mixture is then aligned in magnetic field. After alignment, the mixture is pressed into a green compact for heat-treatment (hot-pressing and/or hot deformation). The MM-Fe—B particles and LMP alloy powder in the green compact form grain boundaries (or, interchangeably, grain boundary layers) defined between the MM-Fe—B particles, shown as boundaries 140 in FIG. 5(a). In some embodiments, the green compact includes MM₂-Fe₁₄—B grains having an average grain size below 500 nm, in other embodiments 100 to 500 nm, and in yet another embodiment 200 to 500 nm.

The green compact is hot-pressed along a direction perpendicular to the alignment direction. In certain embodiments, the alignment, pressing, and hot-pressing can be done in a single step, i.e., while applying the magnetic field to align the powders, the powders can be pressed, and the temperature can be gradually increased to improve density. In other embodiments, two of the alignment, pressing, and hot-pressing can be combined in a single step. Hot-pressing the compact without first aligning includes isotropic grains, resulting in a lower magnetic remanence when compared with aligned magnets. In some embodiments, the hot-pressing is at temperatures from 600° C. to 950° C., in other embodiments 700° C. to 925° C., and in yet another embodiment 750° C. to 900° C. Moreover, in certain embodiments, the hot-pressing may be for 1 to 10 min, in other embodiments 2 to 8 min, and in yet another embodiment 3 to 7 minutes. For example, in some embodiments, the hot-pressing may be at 700° C. to 950° C. for 5 min, in other embodiments 725° C. to 925° C. for 5 min, and in yet another embodiment 750° C. to 900° C. for 10 min. At the hot-pressing stage, grain growth should be avoided. Therefore, in embodiments where the pressing temperature is high, the pressing time should be decreased. In some embodiments, alloys with a higher volume ratio of LMP to the rare earth components are pressed at lower pressing temperatures. For example, when a 20 wt. % LMP alloy with a melting of 570° C. is added, the hot-pressing temperature may be selected to be from 600 to 800° C., with a pressing time of 3 to 10 min.

The hot-pressed magnet is then hot-deformed, which improves grain rotation and selective grain growth, thus improving the alignment and increasing the remanence of the magnet, as shown after hot-deformation with aligned grains 120 in FIG. 4(b). Since misalignment between the HDDR powder grains is much smaller than isotropic grains from conventional methods, e.g. melt spun ribbons, the deformation ratio needed to achieve the same level of alignment is much lower to. Furthermore, the shape of the grains undergoes less change. Both of these features improve coercivity of the magnet. The temperature range for hot deformation is also dependent on the ratio and melting point of the LMP alloys, as similar to hot-pressing. For high ratio LMP mixtures, the hot-deformation temperature can be lower than for low LMP content mixtures. For example, with no LMP added, the hot-deformation temperature may be from, in certain embodiments 800 to 1000° C. In another example, with 10 wt % of LMP, the hot-deformation temperature may be, in certain embodiments 700 to 900° C. After hot-deformation, the permanent magnet can be further annealed by removing the load in the same chamber, or by moving the magnet to another chamber.

Referring to FIG. 5, during heat-treatment (hot-pressing and/or hot-deformation) of the green compact 100, the LMP alloy powder 130 diffuses into the grain boundaries 140 of MM₂-Fe₁₄—B grains 120 through driving forces, such as, but not limited to, capillary effect and/or concentration gradient. As such, the pre-heat-treatment (a) grain boundaries 120 are modified by the LMP alloy powder, forming modified boundaries 240 in the magnet 200 after heat-treatment (b). The modification of the grain boundaries 120 by diffusing the LMP alloy 130 may be, in certain embodiments, a modification of the composition of the grain boundaries, and in other embodiments, a modification of grain boundary microstructure. In some embodiments, the modification of the boundaries to form boundaries 240 may be of both composition and microstructure. In at least one embodiment, the modification of the grain boundaries 120 includes thickening of the grain boundaries to form modified boundaries 240 in permanent magnet 200, as shown in FIG. 5 for post-heat-treatment (b). Modification of the grain boundaries, including composition and microstructure, especially grain boundaries thickening effect as shown in FIG. 5, can improve the coercivity of the permanent magnet. Therefore, less expensive rare earth alloys, such as the alloys formed between MM and Cu, Al, Ga, and Zn can improve the coercivity of the magnet by diffusing into the grain boundaries 140. In certain embodiments, where the Pr, Nd, Dy, and/or Tb concentration in the LMP alloys is higher than that of the MM of the magnetic powder, Pr, Nd, Dy, and/or Tb can diffuse into the hard magnetic phase grains and increase the anisotropy field of the surface layer of the grains, therefore increasing coercivity when compared to pure grain boundary modification. In certain embodiments, the magnet may be annealed to thicken grain boundaries.

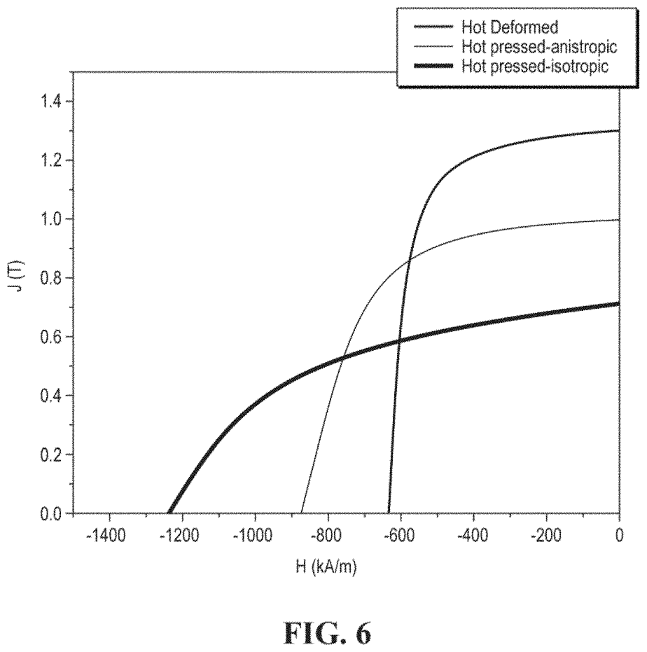

Referring to FIG. 6, the demagnetization curves of magnets prepared from HDDR Nd—Fe—B powders are shown. Although the remanence of the magnet can be improved by aligning and pressing the particles in magnetic field before heat-treatment, the remanence is still only about 1 Tesla due to the misalignment between the grains inside the HDDR particles. By hot-deforming the anisotropic hot-pressed magnet, an increase in remanence of the permanent magnet can be achieved, as shown in FIG. 6. Furthermore, coercivity of the hot-deformed magnet can be improved by adding the LMP alloys, due to the change in microstructure, composition, and/or thickness of the grain boundaries.

According to one or more embodiments, a RE permanent magnet (MM-Fe—B permanent magnet) includes a mischmetal of RE elements such that coercivity and remanence can be improved while using less expensive RE elements. Mischmetal refers to a mixed metal alloy of rare earth elements, such as light rare earth elements, including Ce and La. In certain instances, mischmetal may have the atomic ratio of the naturally mined ore, including the Ce and La phases along with expensive rare earth phases such as Nd, Pr, Dy, and/or Tb. According to at least one embodiment, the MM₂Fe₁₄B average grain size is between 50 and 500 nm. In certain embodiments, the MM-Fe—B particle powders may be processed by utilizing hydrogenation disproportionation desorption and recombination (HDDR) in order to produce anisotropic particles with grain sizes in some embodiments, from 100 to 500 nm, and in other embodiments 150 to 500 nm.

The MM-Fe—B permanent magnet further includes a low melting point (LMP) alloy, the LMP alloy formed between RE elements and other metallic elements, such as, but not limited to, Fe, Co, Cu, Al, Zn, Ga, or combinations thereof. The LMP alloy modifies the grain boundaries in the MM-Fe—B permanent magnet to increase coercivity of the permanent magnet, when compared to permanent magnets without the LMP alloy additive. The LMP alloy may be prepared by arc-melting or any other suitable method. The MM-Fe—B powder and LMP alloy powders are mixed to form a mixture, prior to heat-treatment. In certain embodiments, the percent of the LMP powder in the mixture at most 30% by weight, in other embodiments 5% to 30% by weight, and in yet another embodiment 10% to 25% by weight. In certain embodiments, the composition of the alloy is selected such that the melting point of the alloy is below 750° C.

Referring again to FIG. 5, during processing, the LMP alloy particles 130 can diffuse into the grain boundaries 140 of the MM₂Fe₁₄B grains 120 through various driving forces, including but not limited to capillary effect or concentration gradient. Thus, the grain boundaries in the MM-Fe—B permanent magnet are modified when compared to conventional RE-Fe—B permanent magnets. The grain boundaries are modified by the LMP alloy particles 130, such that the modification affects the boundary composition, thickness, microstructure, or a combination thereof. In embodiments where the thickness of the grain boundaries 240 is greater after LMP alloy diffusion, as schematically shown in FIG. 5, the boundary thickness may be increased by, in some embodiments 0.5 to 5 nm, in other embodiments, 1 nm to 4.5 nm, and in yet another embodiment 1.5 to 4 nm. In certain embodiments, the permanent magnet includes a modified composition of the grain boundaries, and in other embodiments, a modified grain boundary microstructure. In some embodiments, the boundaries 240 may have a modified composition and modified microstructure. In at least one embodiment, the grain boundaries 240 are thicker than grain boundaries 140, as shown in FIG. 5 for post-heat-treatment (b). Modification of the grain boundaries, including composition and microstructure, especially grain boundaries thickening effect as shown in FIG. 5, can improve the coercivity of the permanent magnet. Therefore, less expensive rare earth alloys, such as the alloys formed between MM and Cu, Al, Ga, and Zn can improve the coercivity of the magnet as they are diffused into the grain boundaries 140, and present in modified grain boundaries 240. In certain embodiments, where the Dy, Tb, Pr, and/or Nd concentration in the LMP alloys is higher than that of the MM of the magnetic powder, the Dy, Tb, Pr, and/or Nd is diffused into the hard magnetic phase grains and the anisotropy field of the surface layer of the grains is increased, therefore increasing coercivity when compared to pure grain boundary modification. As such, modification of the grain boundaries can improve coercivity of the MM-Fe—B permanent magnet, when compared to conventional permanent magnets.

According to at least one embodiment, a RE-Fe—B permanent magnet includes the less expensive, and more naturally occurring RE elements. A processing technique to improve the coercivity and remanence of less expensive rare earth based mischmetal-Fe—B magnet utilizes anisotropic HDDR powders which have much finer grains when compared to conventional sintered magnets. The HDDR powder is mixed with low melting point (LMP) alloys, and consolidated by hot pressing. The subsequent hot deformation further improves the alignment and remanence. During both hot pressing and hot deformation, the low melting point alloys modify the microstructure and/or composition of the grain boundaries, thus improving the coercivity of the magnet. In at least one embodiment, a RE-Fe—B permanent magnet includes mischmetal RE grains, and modified grain boundaries. The modified grain boundaries include diffused LMP alloy, and have a specific microstructure and/or composition based on the LMP alloy. Therefore, lower cost and high performance permanent magnets include MM₂Fe₁₄B grains and LMP alloy modified grain boundaries, thus decreasing demand for less-naturally occurring rare earth elements such as Nd, Pr, Dy, and Tb.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of forming a permanent magnet comprising:
processing a mixture of mischmetal-Fe—B particles having an average MM₂Fe₁₄B grain size below 500 nm and low melting point (LMP) alloy particles into a compact defining grain boundaries between MM₂Fe₁₄B grains;
hot-pressing the compact; and
hot-deforming the compact to diffuse the LMP alloy particles into the grain boundaries, thickening the grain boundaries and modifying a surface region composition of the MM₂Fe₁₄B grains.

2. The method of claim 1, wherein the hot-pressing is conducted in a direction perpendicular to an alignment direction.

3. The method of claim 1, wherein the hot-pressing is conducted at 600 to 950° C.

4. The method of claim 1, further comprising forming the mischmetal-Fe—B particles by hydrogenation disproportionation desorption and recombination, wherein the mischmetal-Fe—B particles are anisotropic.

5. The method of claim 1, wherein the processing includes aligning the mischmetal-Fe—B particles and pressing the mischmetal-Fe—B particles and LMP particles to form the compact.

6. The method of claim 1, wherein the mischmetal-Fe—B particles include Tb, Dy, Nd, Pr, Ce, La, or mixtures thereof.

7. The method of claim 1, wherein the mischmetal-Fe—B particles include Co, Cu, Al, Ga, Zn, Si, Nb, Zr or mixtures thereof.

8. The method of claim 1, wherein the LMP alloy particles include at least one rare earth element, and Cu, Al, Ga, Zn, Fe, Co, or mixtures thereof, and have a melting point below 750° C.

9. The method of claim 1, wherein the mixture includes up to 30 wt. % of LMP alloy particles.

10. The method of claim 1, wherein the hot-deforming includes further aligning the mischmetal-Fe—B grains.

11. A method of forming a permanent magnet comprising:
forming anisotropic mischmetal(MM)-Fe—B particles with an average MM₂Fe₁₄B grain size below 500 nm by hydrogenation disproportionation desorption and recombination;
mixing the MM-Fe—B particles with low melting point (LMP) alloy particles to form a mixture;
aligning and pressing the mixture into a compact defining grain boundaries between MM₂Fe₁₄B grains; and
hot-pressing and hot-deforming the compact to diffuse the LMP alloy particles to thicken the grain boundaries.

12. The method of claim 11, wherein the hot-pressing is conducted at 600 to 950° C.

13. The method of claim 11, wherein the mischmetal-Fe—B particles include Tb, Dy, Nd, Pr, Ce, La, or mixtures thereof and Co, Cu, Al, Ga, Zn, Si, Nb, Zr, or mixtures thereof.

14. The method of claim 11, wherein the hot-pressing and hot-deforming the compact modifies a surface region composition of the MM₂Fe₁₄B grains.

15. The method of claim 11, wherein the LMP alloy particles include at least one rare earth element, and Cu, Al, Ga, Zn, Fe, Co, or mixtures thereof.

16. The method of claim 11, wherein the LMP alloy particles have a melting point below 750° C.

17. A rare earth permanent magnet comprising:
anisotropic mischmetal-Fe—B particles having an average MM₂Fe₁₄B grain size below 500 nm; and
modified grain boundaries defined between MM₂Fe₁₄B grains, wherein the modified grain boundaries include a low melting point (LMP) alloy, and a thickness of the modified grain boundaries is greater than a grain boundary thickness lacking the LMP alloy.

18. The rare earth permanent magnet of claim 17, wherein the mischmetal-Fe—B particles include Dy, Tb, Nd, Pr, Ce, La, or mixtures thereof.

19. The rare earth permanent magnet of claim 17, wherein the mischmetal-Fe—B particles include Co, Cu, Al, Ga, Zn, Si, Nb, Zr, or mixtures thereof

20. The rare earth permanent magnet of claim 17, wherein the LMP alloy comprises at most 30 wt. % of the rare earth permanent magnet.
